(19) United States
(12) Patent Application Publication
(10) Pub. No.: US 2025/0039903 A1
(43) Pub. Date: Jan. 30, 2025

(54) ENHANCED SLOT FORMAT FOR PSFCH RECEIVE BEAM SWEEPING

(71) Applicant: Nokia Technologies Oy, Espoo (FI)

(72) Inventors: Daniel MEDINA, München (DE); Torsten WILDSCHEK, Gloucester (GB); Sayed Ali MARANDI, Aalborg (DK); Takayuki SHIMIZU, Mountain View, CA (US); Claude ARZELIER, Molieressur-Ceze (FR)

(21) Appl. No.: 18/776,512

(22) Filed: Jul. 18, 2024

Related U.S. Application Data
(60) Provisional application No. 63/528,507, filed on Jul. 24, 2023.

(51) Int. Cl. H04W 72/25; H04W 72/0446

(52) U.S. Cl. CPC H04W 72/25; H04W 72/0446

(57) ABSTRACT

An apparatus including at least one processor; and at least one memory storing instructions that, when executed by the at least one processor, cause the apparatus at least to: determine a transmit beam or a time-domain resource associated with a sidelink transmission; and determine at least one physical sidelink feedback channel transmission symbol within a slot for a physical sidelink feedback channel transmission in response to the sidelink transmission at least based on the determined transmit beam or time-domain resource.

### TECHNICAL FIELD

The examples and non-limiting example embodiments relate generally to communications and, more particularly, to enhanced slot format for PSFCH beam sweeping.

### BACKGROUND

It is known to implement communication between two terminal devices in a communication network.

### BRIEF DESCRIPTION OF THE DRAWINGS

The foregoing aspects and other features are explained in the following description, taken in connection with the accompanying drawings.

FIG. 1 shows a PSSCH-to-PSFCH resource mapping according to 3GPP TS 38.213.

FIG. 2 shows an example of PSFCH resources (PSFCH_{1,1}, . . . , PSFCH_{M,N}) mapped to different SL CSI-RSs multiplexed within a same slot-subchannel pair.

FIG. 3 shows a dedicated PSFCH slot format for fast PSFCH receive beam sweeping.

FIG. 4 is a block diagram of one possible and non-limiting system in which the example embodiments may be practiced.

FIG. 5 is an example apparatus configured to implement the examples described herein.

FIG. 6 shows a representation of an example of non-volatile memory media used to store instructions that implement the examples described herein.

FIG. 7 is an example method, based on the examples described herein.

### DETAILED DESCRIPTION OF EXAMPLE EMBODIMENTS

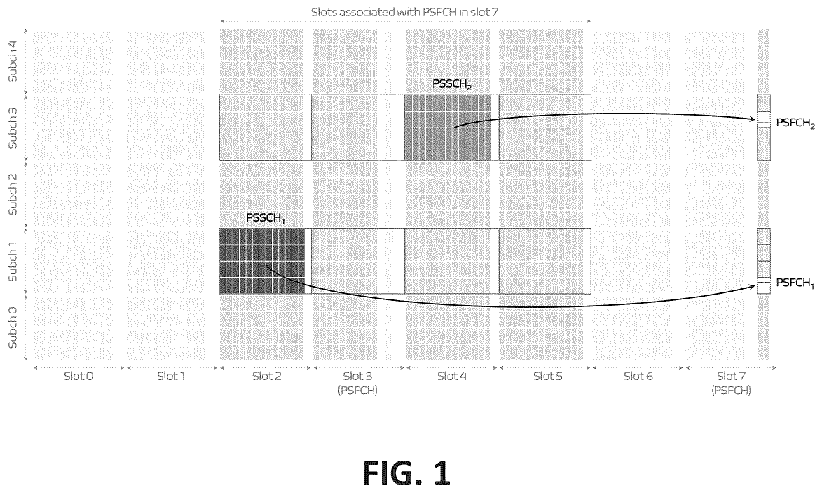

The examples described herein relate to an enhanced slot format for PSFCH beam sweeping. FIG. 1 illustrates an example of the PSSCH-to-PSFCH resource mapping according to 3GPP TS 38.213, clause 16.3 “UE procedure for reporting and obtaining control information in PSFCH”, which was introduced in Rel-16 NR sidelink specifications. For PSSCH transmissions occurring in slots 2-5 (e.g., PSSCH₁, PSSCH₂), the associated PSFCH transmission occasion occurs in the last few symbols of slot 7. The corresponding PSFCH resources are selected among a set of R_{PRB,CS}^{PSFCH} candidate PSFCH resources, corresponding to a set of physical resource blocks (PRB) and/or cyclic shift (CS) pairs, mapped to the slot and subchannel(s) in which the PSSCH is transmitted. The specific PSFCH resource (e.g., PSFCH₁, PSFCH₂) among the R_{PRB,CS}^{PSFCH} candidate PSFCH resources is selected based at least on the L1 source ID of the PSSCH transmitter UE.

The currently standardized PSSCH-to-PSFCH resource mapping defines a correspondence between a given slot-subchannel pair and a set of candidate PSFCH resources. However, for SL beam management in FR2, standalone SL reference signals (e.g., SL CSI-RS) are being considered which may occupy only a small portion of the resource elements (REs) within a slot-subchannel, without any accompanying SL data mapped to the remaining REs.

In order to take advantage of the unused REs, standalone SL CSI-RSs (for transmission by different UEs, or using different beams of a same UE) may be multiplexed by using different time-domain allocations (e.g., OFDM symbols) within a slot (TDM) and/or different frequency-domain allocations (e.g., subcarriers) within a resource block (FDM).

If PSFCH is used for beam reporting (e.g., to indicate that a beam associated with a specific SL CSI-RS has resulted in an acceptable received signal strength), then it is desirable for the PSFCH transmission to indicate which of the multiplexed SL CSI-RSs the PSFCH refers to.

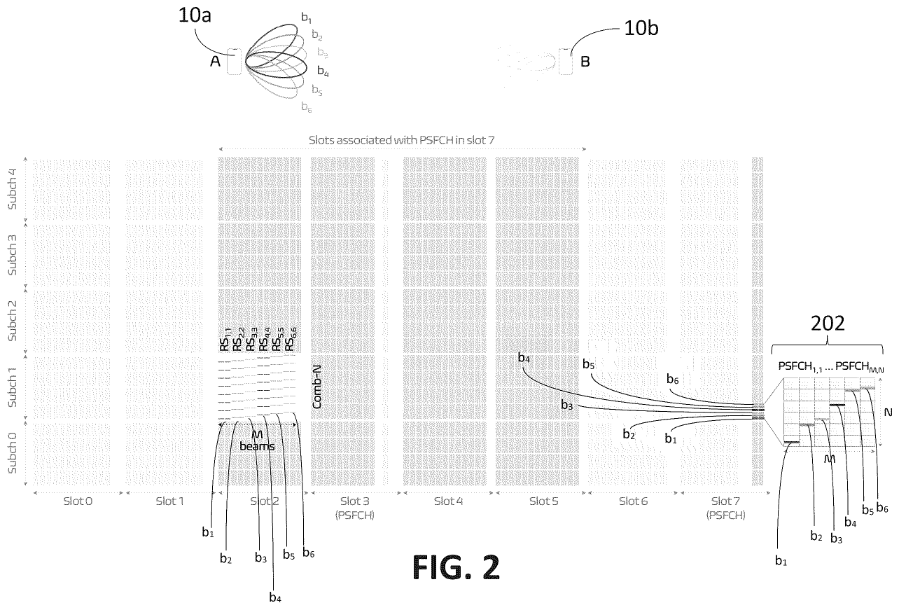

For example, standalone SL CSI-RS may be based on a comb-N structure, i.e., occupying only every N^{th} subcarrier in the frequency domain, as illustrated in FIG. 2 for N=6. In this example, a first UE (A) may wish to perform SL beam alignment with a second UE (B). The first UE (A) may use different OFDM symbols within a same slot to transmit different SL CSI-RSs (RS_{1,1}, . . . , RS_{M,N}) using M different transmit beams (b₁, . . . , b_{M}). Upon measuring the different SL CSI-RSs (RS_{1,1}, . . . , RS_{M,N}), the second UE (B) may determine to transmit one or more PSFCH transmission(s) (PSFCH_{1,1}, . . . , PSFCH_{M,N}), e.g., to indicate to the first UE (A) that one or more of its transmit beam(s) (b₁, . . . , b_{M}) has/have resulted in an acceptable received signal strength (e.g., RSRP) measurement at the second UE (B).

As shown in FIG. 2, the legacy set of RPRB,CSPSFCH candidate PSFCH resources available (e.g., for HARQ-ACK multiplexing) corresponding to a given slot and subchannel(s) (specified in clause 16.3 of 3GPP TS 38.213) may be partitioned into subsets (of equal size) (PSFCH_{1,1}, . . . , PSFCH_{M,N}), each mapped to a different SL CSI-RS transmit beam (b₁, . . . , b_{M}) and/or SL CSI-RS transmission comb (c₁, . . . , c_{N}) in frequency. In this way, a PSFCH transmission may implicitly convey information related to the specific transmit beam and/or transmission comb used for the associated SL CSI-RS transmission.

However, if the subsets of candidate PSFCH resources (PSFCH_{1,1}, . . . , PSFCH_{M,N}) mapped to the different SL CSI-RS transmit beams (b₁, . . . , b_{M}) overlap in time, the first UE (A) 10a may need to use a wide PSFCH receive beam covering the angular range of all its SL CSI-RS transmit beams (b₁, . . . , b_{M}), in order to be able to receive potential PSFCH transmission(s) from any of the associated directions. This has the disadvantage of a lower PSFCH received signal quality as a result of lower receive gain and increased interference due to the wider PSFCH receive beam.

Shown also in FIG. 2 is UE (B) 10b and mapping 202 of PSFCH resources available (e.g., for HARQ-ACK multiplexing) corresponding to a given slot and subchannel(s) (specified in clause 16.3 of 3GPP TS 38.213) partitioned into subsets (of equal size) (PSFCH₁,i, . . . , PSFCH_{M,N}) to a different SL CSI-RS transmit beam (b₁, . . . , b_{M}), including beams b₁, b₂, b₃, b₄, b₅, and b₆. The mapping 202 may also map PSFCH resources available (PSFCH₁,1, . . . , PSFCH_{M,N}) to a SL CSI-RS transmission comb (c₁, . . . , c_{N}) in frequency.

As shown in FIG. 2, RS_{1,1} corresponds to beam b₁, RS_{2,2} corresponds to beam b₂, RS_{3,3} corresponds to beam b₃, RS_{4,4} corresponds to beam b₄, RS_{5,5} corresponds to beam b₅, and RS_{6,6} corresponds to beam b₆.

### Enhanced Slot Format for PSFCH Receive Beam Sweeping

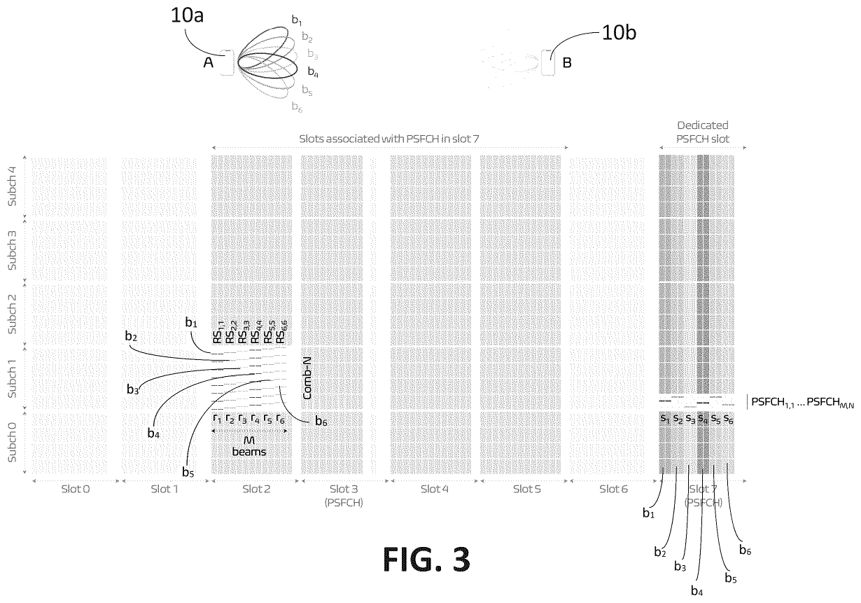

It is proposed to introduce a new dedicated PSFCH slot format to allow for fast PSFCH receive beam sweeping. As shown in FIG. 3, different OFDM symbols (s₁, . . . , s_{M}) within a slot (e.g., slot 7), where FIG. 3 shows symbols s₁, s₂, s₃, s₄, s₅, s₆, may be used to transmit/receive PSFCH associated with different SL CSI-RS (or PSSCH) transmit beams (b₁, . . . , b_{M}). A transmitter UE (A) may perform receive beam sweeping using a set of PSFCH receive beams, corresponding to a set of SL CSI-RS (or PSSCH) transmit beams (b₁, . . . , b_{M}), to receive feedback from multiple directions within a single slot, rather than having to wait for PSFCH transmission occasions across many slots or having to use a wide PSFCH receive beam. A receiving UE (B) may determine a (set of) PSFCH transmission symbol(s) (s₁, . . . , s_{M}) within the slot for transmitting PSFCH based at least on a transmit beam (b₁, . . . , b_{M}) or time-domain resource (r₁, . . . , r_{M}) (e.g., symbol index, slot, etc.) associated with the received SL CSI-RS (or PSSCH) transmission.

As shown in FIG. 3, symbol s₁ is associated with beam b₁, symbol s₂ is associated with beam b₂, symbol s₃ is associated with beam b₃, symbol s₄ is associated with beam b₄, symbol s₅ is associated with beam b₅, symbol s₆ is associated with beam b₆. As shown in FIG. 3, time-domain resource r₁ and SL CSI-RS RS_{1,1} correspond to beam b₁, time-domain resource r₂ and SL CSI-RS RS_{2,2} correspond to beam b₂, time-domain resource r₃ and SL CSI-RS RS_{3,3} correspond to beam b₃, time-domain resource r₄ and SL CSI-RS RS_{4,4} correspond to beam b₄, time-domain resource r₅ and SL CSI-RS RS_{5,5} correspond to beam b₅, and time-domain resource r₆ and SL CSI-RS RS_{6,6} correspond to beam b₆.

FIG. 3 is only an example, and other beam allocations within a slot or other time unit are possible (for example for a future Radio Access Technology such as 6G).

Described herein is the following:

1. An apparatus comprising at least one processor; and at least one memory storing instructions that, when executed by the at least one processor, cause the apparatus at least to: a. determine a transmit beam (b₁, . . . , b_{M}) or a time-domain resource (r₁, . . . , r_{M}) associated with a sidelink transmission, b. determine at least one PSFCH transmission symbol (s₁, . . . s_{M}) within a slot for a PSFCH transmission in response to the sidelink transmission at least based on the determined transmit beam (b₁, . . . , b_{M}) or time-domain resource (r₁, . . . , r_{M})

### First UE (A)

2. The instructions may further cause the apparatus to: c. perform the sidelink transmission using the determined transmit beam (b₁, . . . , b_{M}), d. listen for the PSFCH transmission in the determined at least one PSFCH transmission symbol (s₁, . . . , s_{M}) using a receive beam associated with the determined transmit beam (b₁, . . . , b_{M})

3. The instructions may further cause the apparatus to: e. transmit control information (e.g., SCI) indicating the determined transmit beam (b₁, . . . , b_{M}).

4. The instructions may further cause the apparatus to: f. perform a plurality of sidelink transmissions using a plurality of transmit beams (b₁, . . . , b_{M}) and a plurality of time-domain resources (r₁, . . . , r_{M}), g. determine, at least based on the plurality of transmit beams (b₁, . . . , b_{M}) or the plurality of time-domain resources (r₁, . . . , r_{M}), a corresponding plurality of PSFCH transmission symbols (s₁, . . . , s_{M}) within a slot for PSFCH transmissions in response to the plurality of sidelink transmissions, h. listen for said PSFCH transmissions in the determined plurality of PSFCH transmission symbols (s₁, . . . , s_{M}) using a respective plurality of receive beams associated with the plurality of transmit beams (b₁, . . . , b_{M}).

### Second UE (B)

5. The instructions may further cause the apparatus to: c. receive the sidelink transmission, d. determine whether to perform the PSFCH transmission in the determined at least one PSFCH transmission symbol (s₁, . . . , s_{M}) at least based on a measurement (e.g., RSRP) associated with the sidelink transmission.

6. The instructions may further cause the apparatus to: e. determine to perform the PSFCH transmission in the determined at least one PSFCH transmission symbol (s₁, . . . , s_{M}) if the measurement (e.g., RSRP) is above a threshold.

7. The instructions may further cause the apparatus to: f. receive control information (e.g., SCI) indicating the transmit beam (b₁, . . . , b_{M}) or time-domain resource (r₁, . . . , r_{M}), g. determine the at least one PSFCH transmission symbol (s₁, . . . , s_{M}) based on the received control information (e.g., SCI).

Advantages and technical effects of the herein described enhancement include that the herein described enhancement allows a (SL CSI-RS or PSSCH) transmitter UE (A) to perform fast PSFCH receive beam sweeping within a slot, avoiding the need to use a wide PSFCH receive beam and the consequent reduction in PSFCH received signal quality. This is not possible with the legacy PSSCH-to-PSFCH resource mapping.

In one embodiment, the (legacy) set of RPRB,CSPSFCH candidate PSFCH resources available (e.g., for HARQ-ACK multiplexing) corresponding to a given slot and subchannel(s) may be partitioned into M subsets (of equal size), each subset mapped to a different (SL CSI-RS or PSSCH) transmit beam (b₁, . . . , b_{M}) and/or time-domain resource (r₁, . . . , r_{M}), indexed by m=0, . . . , M−1, wherein each subset occurs in a different (set of) PSFCH transmission symbol(s) (s₁, . . . , s_{M}) within the same slot, as illustrated in FIG. 3. For example, a first subset of PSFCH resources corresponding to PSFCH resource indices 0, . . . , RPRB,CSPSFCH/M−1 may be associated with transmit beam b₁ and/or time-domain resource r₁ (m=0) and occur in a first (set of) PSFCH transmission symbol(s) {0, 1} within the slot; a second subset of PSFCH resources corresponding to PSFCH resource indices RPRB,CSPSFCH/M−1 may be associated with transmit beam b₂ and/or time-domain resource r₂ (m=1) and occur in a second (set of) PSFCH transmission symbol(s) {2, 3} within the slot, and so on. In this case, a UE may determine a PSFCH resource index for a PSFCH transmission in response to a sidelink transmission (SL CSI-RS or PSSCH) associated with a transmit beam (b₁, . . . , b_{M}) or time-domain resource (r₁, . . . , r_{M}) indexed by m=0, . . . , M−1 as

$$m \cdot \frac{{R}_{P RB , CS}^{P S F C H}}{M} + ( {P}_{ID} + {M}_{ID} ) mod \frac{{R}_{P RB , CS}^{P S F C H}}{M}$$

where P_{ID} and M_{ID} are defined in clause 16.3 of 3GPP TS 38.213. In this case, it may be assumed that RPRB,CSPSFCH is a multiple of M.

In another embodiment, the (legacy) set of RPRB,CSPSFCH candidate PSFCH resources available (e.g., for HARQ-ACK multiplexing) corresponding to a given slot and subchannel(s) may be partitioned into M×N subsets (of equal size), each mapped to a different combination (m, n) of transmit beam (b₁, . . . , b_{M}) and/or time-domain resource (r₁, . . . , r_{M}), indexed by m=0, . . . , M−1, and frequency-domain resource (e.g., SL CSI-RS transmission comb offset), indexed by n=0, . . . , N−1, wherein subsets associated with a different index m occur in different (sets of) PSFCH transmission symbols (s₁, . . . , s_{M}) within the same slot, as illustrated in FIG. 3. For example, a first subset of PSFCH resources corresponding to PSFCH resource indices 0, . . . , RPRB,CSPSFCH/(M×N)−1 may be associated with SL CSI-RS transmit beam b₁ and/or time-domain resource r₁ (m=0), and SL CSI-RS transmission comb offset n=0 (e.g., corresponding to RS_{1,1} in FIG. 3); a second subset of PSFCH resources corresponding to PSFCH resource indices R_{PRB,CS}^{PSFCH}/(M×N), . . . , 2R_{PRB,CS}^{PSFCH}/(M×N)−1 may be associated with SL CSI-RS transmit beam b₂ and/or time-domain resource r₂ (m=1), and SL CSI-RS transmission comb offset n=0 (e.g., corresponding to RS_{2,1} in FIG. 3), and so on. In this case, a UE may determine a PSFCH resource index for a PSFCH transmission in response to a sidelink transmission (SL CSI-RS or PSSCH) associated with a combination (m, n) as

$$( m + n \cdot M ) \cdot \frac{{R}_{P RB , CS}^{P S F C H}}{M \times N} + ( {P}_{ID} + {M}_{ID} ) mod \frac{{R}_{P RB , CS}^{P S F C H}}{M \times N}$$

$$or$$

$$( n + m \cdot N ) \cdot \frac{{R}_{P RB , CS}^{P S F C H}}{M \times N} + ( {P}_{ID} + {M}_{ID} ) mod \frac{{R}_{P RB , CS}^{P S F C H}}{M \times N}$$

where P_{ID} and M_{ID} are defined in clause 16.3 of 3GPP TS 38.213. In this case, it may be assumed that R_{PRB,CS}^{PSFCH} is a multiple of M×N.

### First UE (A) Behavior

In one embodiment, the first UE (A) may, upon determining a transmit beam (b₁, . . . , b_{M}) or time-domain resource (r₁, . . . , r_{M}) (e.g., symbol index, slot, etc.) associated with a SL CSI-RS (or PSSCH) transmission to be transmitted by the first UE (A), transmit an indication of the determined transmit beam (b₁, . . . , b_{M}) or time-domain resource (r₁, . . . , r_{M}), e.g., using a new SCI field.

Upon transmitting the SL CSI-RS (or PSSCH) transmission using the determined transmit beam (b₁, . . . , b_{M}) and/or time-domain resource (r₁, . . . , r_{M}), the first UE (A) may monitor a corresponding (set of) PSFCH transmission symbol(s) (s₁, . . . , s_{M}) for a potential PSFCH transmission by the second UE (B) in response to its SL CSI-RS (or PSSCH) transmission, using a PSFCH receive beam associated with the determined transmit beam (e.g., based on beam correspondence). For example, if the first UE (A) transmits one or more SL CSI-RS(s) (RS₁, . . . , RS_{M}) using one or more transmit beam(s) (b₁, . . . , b_{M}), reception of PSFCH(s) associated with one or more of the transmitted SL CSI-RS(s) may indicate that the associated beam(s) is/are acceptable for communication with the second UE (B).

In some embodiments, the PSFCH receive beam may be wider than the SL CSI-RS (or PSSCH) transmit beam, so that the mapping between SL CSI-RS (or PSSCH) transmit beams and PSFCH receive beams is not one-to-one. For example, if different SL CSI-RSs (RS₁, . . . , RS₆) are transmitted on 6 different narrow transmit beams (b₁, . . . , b₆), the first UE (A) may use 3 PSFCH receive beams, each with a beamwidth covering the angular range of 2 narrow SL CSI-RS transmit beams, or it may use 2 PSFCH receive beams, each covering the angular range of 3 narrow SL CSI-RS transmit beams.

### Second UE (B) Behavior

In one embodiment, the second UE (B) may receive SCI from the first UE (A) indicating a transmit beam (b₁, . . . , b_{M}) or time-domain resource (r₁, . . . , r_{M}) (e.g., symbol index, slot, etc.) associated with the SL CSI-RS (or PSSCH) transmission from the first UE (A), and determine, based on the received SCI, a corresponding (set of) PSFCH transmission symbol(s) (s₁, . . . , s_{M}) for a potential PSFCH transmission by the second UE (B) in response to the SL CSI-RS (or PSSCH) transmission.

Upon receiving the SL CSI-RS (or PSSCH) transmission form the first UE (A), the second UE (B) may determine whether or not to perform a PSFCH transmission in response. Such determination may be based on a received signal strength (e.g., RSRP) measured at the second UE (B). For example, if the measurement is above a threshold, the second UE (B) may determine to perform the PSFCH transmission. Otherwise, it may determine not to perform the PSFCH transmission.

Although the examples of measurement used herein relate to RSRP, the various embodiments provided are by no means limited to this measurement quantity and may apply to other measurement quantities such as RSSI, RSRQ, RSCP or RS-SINR.

Although the examples provided herein relate to the NR Radio Access Technology (RAT), the various embodiments are by no means limited to this RAT and may apply to other RATs or systems such as LTE, 6G, 7G, etc. They may apply to other systems such as 802.11, Wi-Fi, DECT, etc.

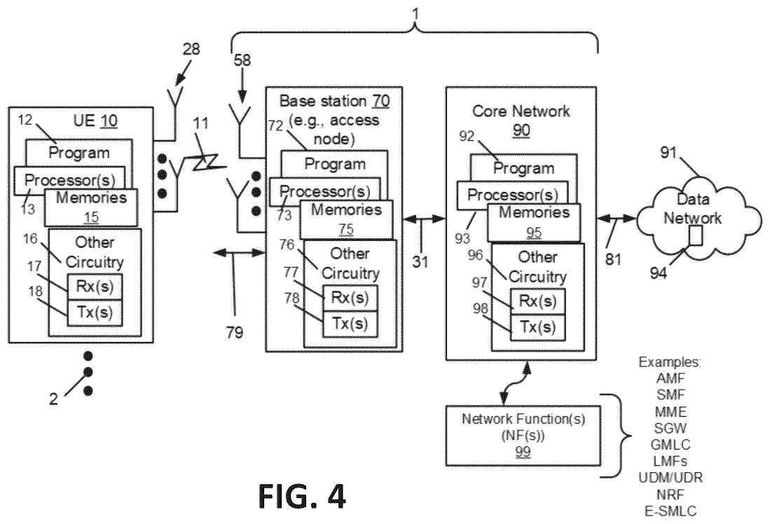

FIG. 4 shows a block diagram of one possible and non-limiting example of a cellular network 1 that is connected to a user equipment (UE) 10. A number of network elements are shown in the cellular network of FIG. 4: a base station 70; and a core network 90.

In FIG. 4, a user equipment (UE) 10 is in wireless communication via radio link 11 with the base station 70 of the cellular network 1. A UE 10 is a wireless communication device, such as a mobile device, that is configured to access a cellular network. The UE 10 is illustrated with one or more antennas 28. The ellipses 2 indicate there could be multiple UEs 10 in wireless communication via radio links with the base station 70. The UE 10 includes one or more processors 13, one or more memories 15, and other circuitry 16. The other circuitry 16 includes one or more receivers (Rx(s)) 17 and one or more transmitters (Tx(s)) 18. A program 12 is used to cause the UE 10 to perform the operations described herein. For a UE 10, the other circuitry 16 could include circuitry such as for user interface elements (not shown) like a display.

The base station 70, as a network element of the cellular network 1, provides the UE 10 access to cellular network 1 and to the data network 91 via the core network 90 (e.g., via a user plane function (UPF) of the core network 90). The base station 70 is illustrated as having one or more antennas 58. In general, the base station 70 is referred to as RAN node 70 herein. An example of a RAN node 70 is a gNB. There are, however, many other examples of RAN nodes including an eNB (LTE base station) or transmission reception point (TRP). The base station 70 includes one or more processors 73, one or more memories 75, and other circuitry 76. The other circuitry 76 includes one or more receivers (Rx(s)) 77 and one or more transmitters (Tx(s)) 78. A program 72 is used to cause the base station 70 to perform the operations described herein.

It is noted that the base station 70 may instead be implemented via other wireless technologies, such as Wi-Fi (a wireless networking protocol that devices use to communicate without direct cable connections). In the case of Wi-Fi, the link 11 could be characterized as a wireless link.

Two or more base stations 70 communicate using, e.g., link(s) 79. The link(s) 79 may be wired or wireless or both and may implement, e.g., an Xn interface for fifth generation (5G), an X2 interface for LTE, or other suitable interface for other standards.

The cellular network 1 may include a core network 90, as a third illustrated element or elements, that may include core network functionality, and which provide connectivity via a link or links 81 with a data network 91, such as a telephone network and/or a data communications network (e.g., the Internet). The core network 90 includes one or more processors 93, one or more memories 95, and other circuitry 96. The other circuitry 96 includes one or more receivers (Rx(s)) 97 and one or more transmitters (Tx(s)) 98. A program 92 is used to cause the core network 90 to perform the operations described herein.

The core network 90 could be a 5GC (5G core network). The core network 90 can implement or comprise multiple network functions (NF(s)) 99, and the program 92 may comprise one or more of the NFs 99. A 5G core network may use hardware such as memory and processors and a virtualization layer. It could be a single standalone computing system, a distributed computing system, or a cloud computing system. The NFs 99, as network elements, of the core network could be containers or virtual machines running on the hardware of the computing system(s) making up the core network 90.

Core network functionality for 5G may include access and mobility management functionality that is provided by a network function 99 such as an access and mobility management function (AMF(s)), session management functionality that is provided by a network function such as a session management function (SMF). Core network functionality for access and mobility management in an LTE network may be provided by an MME (Mobility Management Entity) and/or SGW (Serving Gateway) functionality, which routes data to the data network. Many others are possible, as illustrated by the examples in FIG. 4: AMF; SMF; MME; SGW; gateway mobile location center (GMLC); location management functions (LMFs); unified data management (UDM); unified data repository (UDR); network repository function (NRF); and/or evolved serving mobile location center (E-SMLC). These are merely exemplary core network functionality that may be provided by the core network 90, and note that both 5G and LTE core network functionality might be provided by the core network 90. The radio access network (RAN) node 70 is coupled via a backhaul link 31 to the core network 90. The RAN node 70 and the core network 90 may include an NG interface for 5G, or an S1 interface for LTE, or other suitable interface for other radio access technologies for communicating via the backhaul link 31.

In the data network 91, there is a computer-readable medium 94. The computer-readable medium 94 contains instructions that, when downloaded and installed into the memories 15, 75, or 95 of the corresponding UE 10, base station 70, and/or core network element(s) 90, and executed by processor(s) 13, 73, or 93, cause the respective device to perform corresponding actions described herein. The computer-readable medium 94 may be implemented in other forms, such as via a compact disc or memory stick.

The programs 12, 72, and 92 contain instructions stored by corresponding one or more memories 15, 75, or 95. These instructions, when executed by the corresponding one or more processors 13, 73, or 93, cause the corresponding apparatus 10, 70, or 90, to perform the operations described herein. The computer readable memories 15, 75, or 95 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 15, 75, and 95 may be means for performing storage functions. The processors 13, 73, and 93, may be of any type suitable to the local technical environment, and may include one or more of general-purpose computers, special purpose computers, microprocessors, digital signal processors (DSPs) and processors based on a multi-core processor architecture, as non-limiting examples. The processors 13, 73, and 93 may be means for causing their respective apparatus to perform functions, such as those described herein.

The receivers 17, 77, and 97, and the transmitters 18, 78, and 98 may implement wired or wireless interfaces. The receivers and transmitters may be grouped together as transceivers.

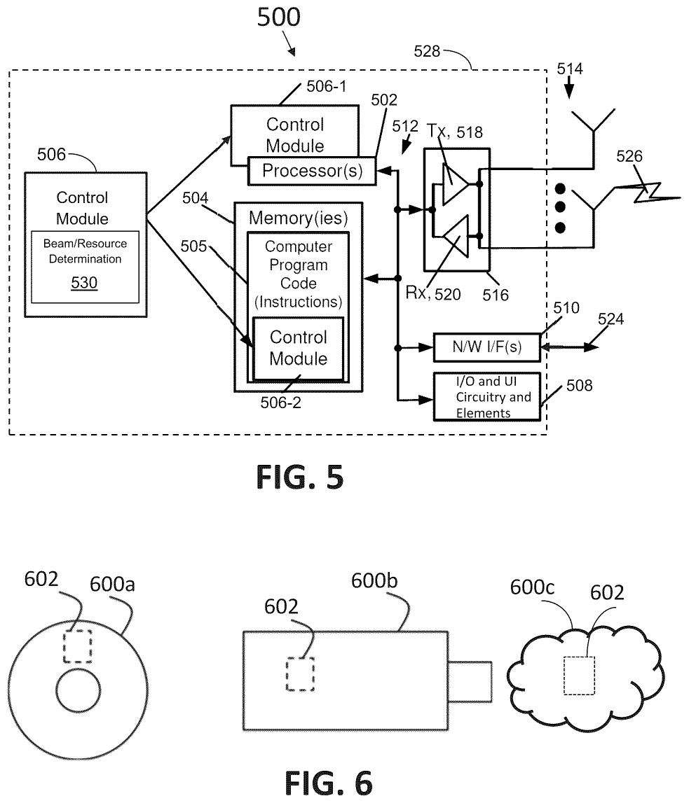

FIG. 5 is an example apparatus 500, which may be implemented in hardware, configured to implement the examples described herein. The apparatus 500 comprises at least one processor 502 (e.g. an FPGA and/or CPU), one or more memories 504 including computer program code 505, the computer program code 505 having instructions to carry out the methods described herein, wherein the at least one memory 504 and the computer program code 505 are configured to, with the at least one processor 502, cause the apparatus 500 to implement circuitry, a process, component, module, or function (implemented with control module 506) to implement the examples described herein, including enhanced slot format for PSFCH beam sweeping. The memory 504 may be a non-transitory memory, a transitory memory, a volatile memory (e.g. RAM), or a non-volatile memory (e.g. ROM). Beam or resource determination 530 of the control module implements the herein described aspects related to enhanced slot format for PSFCH beam sweeping.

The apparatus 500 includes a display and/or I/O interface 508, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g. network (N/W) interfaces (I/F(s)) 510. The communication I/F(s) 510 may be wired and/or wireless and communicate over the Internet/other network(s) via any communication technique including via one or more links 524. The link(s) 524 may be the link(s) 11 and/or 79 and/or 31 and/or 81 from FIG. 5. The link(s) 11 and/or 79 and/or 31 and/or 81 from FIG. 5 may also be implemented using transceiver(s) 516 and corresponding wireless link(s) 526. The communication I/F(s) 510 may comprise one or more transmitters or one or more receivers.

The transceiver 516 comprises one or more transmitters 518 and one or more receivers 520. The transceiver 516 and/or communication I/F(s) 510 may comprise standard well-known components such as an amplifier, filter, frequency-converter, (de)modulator, and encoder/decoder circuitries and one or more antennas, such as antennas 514 used for communication over wireless link 526.

The control module 506 of the apparatus 500 comprises one of or both parts 506-1 and/or 506-2, which may be implemented in a number of ways. The control module 506 may be implemented in hardware as control module 506-1, such as being implemented as part of the one or more processors 502. The control module 506-1 may be implemented also as an integrated circuit or through other hardware such as a programmable gate array. In another example, the control module 506 may be implemented as control module 506-2, which is implemented as computer program code (having corresponding instructions) 505 and is executed by the one or more processors 502. For instance, the one or more memories 504 store instructions that, when executed by the one or more processors 502, cause the apparatus 500 to perform one or more of the operations as described herein. Furthermore, the one or more processors 502, the one or more memories 504, and example algorithms (e.g., as flowcharts and/or signaling diagrams), encoded as instructions, programs, or code, are means for causing performance of the operations described herein.

The apparatus 500 to implement the functionality of control 506 may be UE 10, base station 70 (e.g. gNB 70), or core network 90. Thus, processor 502 may correspond to processor(s) 13, processor(s) 73 and/or processor(s) 93, memory 504 may correspond to one or more memories 15, one or more memories 75 and/or one or more memories 95, computer program code 505 may correspond to program 12, program 72, or program 92, communication I/F(s) 510 and/or transceiver 516 may correspond to other circuitry 16, other circuitry 76, or other circuitry 96, and antennas 514 may correspond to antennas 28 or antennas 58.

The apparatus 500 may correspond to first UE (A) 10a or second UE (B) 10b.

Alternatively, apparatus 500 and its elements may not correspond to either of UE 10, base station 70, or core network and their respective elements, as apparatus 500 may be part of a self-organizing/optimizing network (SON) node or other node, such as a node in a cloud.

The apparatus 500 may also be distributed throughout the network (e.g. 91) including within and between apparatus 500 and any network element (such as core network 90 and/or the base station 70 and/or the UE 10).

Interface 512 enables data communication and signaling between the various items of apparatus 500, as shown in FIG. 5. For example, the interface 512 may be one or more buses such as address, data, or control buses, and may include any interconnection mechanism, such as a series of lines on a motherboard or integrated circuit, fiber optics or other optical communication equipment, and the like. Computer program code (e.g. instructions) 505, including control 506 may comprise object-oriented software configured to pass data or messages between objects within computer program code 505. The apparatus 500 need not comprise each of the features mentioned, or may comprise other features as well. The various components of apparatus 500 may at least partially reside in a common housing 528, or a subset of the various components of apparatus 500 may at least partially be located in different housings, which different housings may include housing 528.

FIG. 6 shows a schematic representation of non-volatile memory media 600a (e.g. computer/compact disc (CD) or digital versatile disc (DVD)) and 600b (e.g. universal serial bus (USB) memory stick) and 600c (e.g. cloud storage for downloading instructions and/or parameters 602 or receiving emailed instructions and/or parameters 602) storing instructions and/or parameters 602 which when executed by a processor allows the processor to perform one or more of the steps of the methods described herein.

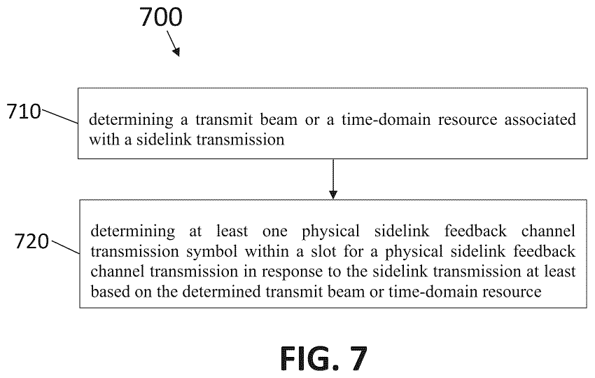

FIG. 7 is an example method 700, based on the example embodiments described herein. At 710, the method includes determining a transmit beam or a time-domain resource associated with a sidelink transmission. At 720, the method includes determining at least one physical sidelink feedback channel transmission symbol within a slot for a physical sidelink feedback channel transmission in response to the sidelink transmission at least based on the determined transmit beam or time-domain resource. Method 700 may be performed with UE 10, UE 10a, UE 10b, or apparatus 500.

The following examples are provided and described herein.

Example 1. An apparatus comprising: at least one processor; and at least one memory storing instructions that, when executed by the at least one processor, cause the apparatus at least to: determine a transmit beam or a time-domain resource associated with a sidelink transmission; and determine at least one physical sidelink feedback channel transmission symbol within a slot for a physical sidelink feedback channel transmission in response to the sidelink transmission at least based on the determined transmit beam or time-domain resource.

Example 2. The apparatus of example 1, wherein the sidelink transmission comprise a reference signal transmission or a data transmission.

Example 3. The apparatus of any of examples 1 to 2, wherein there are a number of transmit beams, a number of time-domain resources corresponding to the number of transmit beams, and a number of physical sidelink feedback channel transmission symbols corresponding to the number of transmit beams.

Example 4. The apparatus of any of examples 1 to 3, wherein the instructions, when executed by the at least one processor, cause the apparatus at least to: perform the sidelink transmission using the determined transmit beam; and listen for the physical sidelink feedback channel transmission in the determined at least one physical sidelink feedback channel transmission symbol using a receive beam associated with the determined transmit beam.

Example 5. The apparatus of any of examples 1 to 4, wherein the instructions, when executed by the at least one processor, cause the apparatus at least to: transmit control information indicating the determined transmit beam.

Example 6. The apparatus of example 5, wherein the control information comprises sidelink control information.

Example 7. The apparatus of any of examples 1 to 6, wherein the instructions, when executed by the at least one processor, cause the apparatus at least to: perform a plurality of sidelink transmissions using a plurality of transmit beams and a plurality of time-domain resources; determine, at least based on the plurality of transmit beams or the plurality of time-domain resources, a corresponding plurality of physical sidelink feedback channel transmission symbols within a slot for physical sidelink feedback channel transmissions in response to the plurality of sidelink transmissions; and listen for said physical sidelink feedback channel transmissions in the determined plurality of physical sidelink feedback channel transmission symbols using a respective plurality of receive beams associated with the plurality of transmit beams.

Example 8. The apparatus of example 7, wherein: the plurality of transmit beams are narrower than the plurality of receive beams, and a number of the receive beams used for listening for the physical sidelink feedback channel transmissions is less than a number of the transmit beams used for performing the plurality of sidelink transmissions; and a receive beam of the plurality of receive beams covers an angular range of at least two transmit beams of the plurality of transmit beams.

Example 9. The apparatus of any of examples 6 to 8, wherein: the plurality of receive beams are narrower than the plurality of transmit beams, and a number of the receive beams used for listening for the physical sidelink feedback channel transmissions is greater than a number of the transmit beams used for performing the plurality of sidelink transmissions; a transmit beam of the plurality of transmit beams covers an angular range of at least two receive beams of the plurality of receive beams.

Example 10. The apparatus of any of examples 1 to 9, wherein the instructions, when executed by the at least one processor, cause the apparatus at least to: receive the sidelink transmission; and determine whether to perform the physical sidelink feedback channel transmission in the determined at least one physical sidelink feedback channel transmission symbol at least based on a measurement associated with the sidelink transmission.

Example 11. The apparatus of example 10, wherein the measurement comprises a reference signal received power measurement.

Example 12. The apparatus of any of examples 1 to 11, wherein the instructions, when executed by the at least one processor, cause the apparatus at least to: determine to perform the physical sidelink feedback channel transmission in the determined at least one physical sidelink feedback channel transmission symbol when the measurement is above a threshold.

Example 13. The apparatus of any of examples 1 to 12, wherein the instructions, when executed by the at least one processor, cause the apparatus at least to: receive control information indicating the transmit beam or time-domain resource; and determine the at least one physical sidelink feedback channel transmission symbol based on the received control information.

Example 14. The apparatus of example 13, wherein the control information comprises sidelink control information.

Example 15. The apparatus of any of examples 1 to 14, wherein the instructions, when executed by the at least one processor, cause the apparatus at least to: determine a physical sidelink feedback channel resource index for the physical sidelink feedback channel transmission according to:

$$( m + n \cdot M ) \cdot \frac{{R}_{P RB , CS}^{P S F C H}}{M \times N} + ( {P}_{ID} + {M}_{ID} ) mod \frac{{R}_{P RB , CS}^{P S F C H}}{M \times N}$$

$$or$$

$$( n + m \cdot N ) \cdot \frac{{R}_{P RB , CS}^{P S F C H}}{M \times N} + ( {P}_{ID} + {M}_{ID} ) mod \frac{{R}_{P RB , CS}^{P S F C H}}{M \times N}$$

wherein
M is a number of possible transmit beams or time-domain resources for a sidelink transmission;
N is a number of possible frequency-domain resources for the sidelink transmission;
m indicates which of the possible transmit beams or time-domain resources is used by the sidelink transmission;
n indicates which of the possible frequency-domain resources is used by the sidelink transmission;
R_{PRB,CS}^{PSFCH} is a number of physical sidelink feedback channel transmission resources available for multiplexing control information in a physical sidelink feedback channel transmission;
P_{ID} is a physical layer source identifier; and
M_{ID} is a group member identifier.

Example 16. The apparatus of example 15, wherein: m is an integer having a value that ranges from 0 to M−1, and n is an integer having a value that ranges from 0 to N−1.

Example 17. The apparatus of any of examples 15 to 16, wherein at least M is larger than 1.

Example 18. The apparatus of any one of examples 15 to 17, wherein physical sidelink feedback channel (PSFCH) transmission resources corresponding to PSFCH transmission resource indices associated with different values of m occur in different PSFCH transmission symbols within a same slot.

Example 19. A method comprising: determining a transmit beam or a time-domain resource associated with a sidelink transmission; and determining at least one physical sidelink feedback channel transmission symbol within a slot for a physical sidelink feedback channel transmission in response to the sidelink transmission at least based on the determined transmit beam or time-domain resource.

Example 20. An apparatus comprising: means for determining a transmit beam or a time-domain resource associated with a sidelink transmission; and means for determining at least one physical sidelink feedback channel transmission symbol within a slot for a physical sidelink feedback channel transmission in response to the sidelink transmission at least based on the determined transmit beam or time-domain resource.

Example 21. A non-transitory program storage device readable by a machine, tangibly embodying a program of instructions executable by the machine for performing operations, the operations comprising: determining a transmit beam or a time-domain resource associated with a sidelink transmission; and determining at least one physical sidelink feedback channel transmission symbol within a slot for a physical sidelink feedback channel transmission in response to the sidelink transmission at least based on the determined transmit beam or time-domain resource.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, slash, or number, and may be case insensitive):
3GPP third generation partnership project
4G fourth generation
5G fifth generation
5GC 5G core network
6G sixth generation
7G seventh generation
802.11 set of local area network (LAN) technical standards
ACK acknowledgement
AMF access and mobility management function
ASIC application-specific integrated circuit
CD compact/computer disc
CPU central processing unit
CS cyclic shift
CSI channel state information
CSI-RS channel state information reference signal
DECT digital enhanced cordless telecommunications
DSP digital signal processor
DVD digital versatile disc
eNB evolved Node B (e.g., an LTE base station)
EPC evolved packet core
E-SMLC evolved serving mobile location center
FDM frequency division multiplexing
FPGA field-programmable gate array
FR frequency range
GMLC gateway mobile location center
gNB base station for 5G/NR, i.e., a node providing NR user plane and control plane protocol terminations towards the UE, and connected via the NG interface to the 5GC
HARQ hybrid automatic repeat request
ID identifier
I/F interface
I/O input/output
LAN local area network
L1 layer 1
LMF location management function
LTE long term evolution (4G)
MME mobility management entity
N number (e.g. comb-N)
NF network function
NG new generation
NG-RAN new generation radio access network
NR new radio
NRF network repository function
N/W network
OFDM orthogonal frequency division multiplexing
PRB physical resource block
PSFCH physical sidelink feedback channel
PSSCH physical sidelink shared channel
RAM random access memory
RAN radio access network
RAT radio access technology
RE resource element
Rel release
ROM read-only memory
RP RAN plenary
RS reference signal
RSCP received signal code power
RSRP reference signal received power
RSRQ reference signal received quality
RSSI received signal strength indicator
Rx receiver or reception
S1 interface connecting the eNB to the EPC
SCI sidelink control information
SGW serving gateway
SINR signal-to-interference-plus-noise ratio
SL sidelink
SMF session management function
SON self-organizing/optimizing network
Subch subchannel
TDM time division multiplexing
TRP transmission reception point
TS technical specification
Tx transmitter or transmission
UDM unified data management
UDR unified data repository
UE user equipment (e.g., a wireless, typically mobile device)
UI user interface
UPF user plane function
USB universal serial bus
UMTS universal mobile telecommunications system
Uu UMTS air interface
Wi-Fi wireless networking protocol that devices use to communicate without direct cable connections
X2 network interface between RAN nodes and between RAN and the core network
Xn network interface between NG-RAN nodes

1.-21. (canceled)

22. An apparatus comprising:
at least one processor; and
at least one memory storing instructions that, when executed by the at least one processor, cause the apparatus at least to:
determine a transmit beam or a time-domain resource associated with a sidelink transmission; and
determine at least one physical sidelink feedback channel transmission symbol within a slot for a physical sidelink feedback channel transmission in response to the sidelink transmission at least based on the determined transmit beam or time-domain resource.

23. The apparatus of claim 22, wherein the sidelink transmission comprise a reference signal transmission or a data transmission.

24. The apparatus of claim 22, wherein there are a number of transmit beams, a number of time-domain resources corresponding to the number of transmit beams, and a number of physical sidelink feedback channel transmission symbols corresponding to the number of transmit beams.

25. The apparatus of claim 22, wherein the instructions, when executed by the at least one processor, cause the apparatus at least to:
perform the sidelink transmission using the determined transmit beam; and
listen for the physical sidelink feedback channel transmission in the determined at least one physical sidelink feedback channel transmission symbol using a receive beam associated with the determined transmit beam.

26. The apparatus of claim 22, wherein the instructions, when executed by the at least one processor, cause the apparatus at least to:
transmit control information indicating the determined transmit beam.

27. The apparatus of claim 26, wherein the control information comprises sidelink control information.

28. The apparatus of claim 22, wherein the instructions, when executed by the at least one processor, cause the apparatus at least to:
perform a plurality of sidelink transmissions using a plurality of transmit beams and a plurality of time-domain resources;
determine, at least based on the plurality of transmit beams or the plurality of time-domain resources, a corresponding plurality of physical sidelink feedback channel transmission symbols within a slot for physical sidelink feedback channel transmissions in response to the plurality of sidelink transmissions; and
listen for said physical sidelink feedback channel transmissions in the determined plurality of physical sidelink feedback channel transmission symbols using a respective plurality of receive beams associated with the plurality of transmit beams.

29. The apparatus of claim 28, wherein:
the plurality of transmit beams are narrower than the plurality of receive beams, and a number of the receive beams used for listening for the physical sidelink feedback channel transmissions is less than a number of the transmit beams used for performing the plurality of sidelink transmissions; and
a receive beam of the plurality of receive beams covers an angular range of at least two transmit beams of the plurality of transmit beams.

30. The apparatus of claim 27, wherein:
the plurality of receive beams are narrower than the plurality of transmit beams, and a number of the receive beams used for listening for the physical sidelink feedback channel transmissions is greater than a number of the transmit beams used for performing the plurality of sidelink transmissions;
a transmit beam of the plurality of transmit beams covers an angular range of at least two receive beams of the plurality of receive beams.

31. The apparatus of claim 22, wherein the instructions, when executed by the at least one processor, cause the apparatus at least to:
receive the sidelink transmission; and
determine whether to perform the physical sidelink feedback channel transmission in the determined at least one physical sidelink feedback channel transmission symbol at least based on a measurement associated with the sidelink transmission.

32. The apparatus of claim 31, wherein the measurement comprises a reference signal received power measurement.

33. The apparatus of claim 22, wherein the instructions, when executed by the at least one processor, cause the apparatus at least to:
determine to perform the physical sidelink feedback channel transmission in the determined at least one physical sidelink feedback channel transmission symbol when the measurement is above a threshold.

34. The apparatus of claim 22, wherein the instructions, when executed by the at least one processor, cause the apparatus at least to:
receive control information indicating the transmit beam or time-domain resource; and
determine the at least one physical sidelink feedback channel transmission symbol based on the received control information.

35. The apparatus of claim 34, wherein the control information comprises sidelink control information.

36. The apparatus of claim 22, wherein the instructions, when executed by the at least one processor, cause the apparatus at least to:
determine a physical sidelink feedback channel resource index for the physical sidelink feedback channel transmission according to:
$$( m + n \cdot M ) \cdot \frac{{R}_{P RB , CS}^{P S F C H}}{M \times N} + ( {P}_{ID} + {M}_{ID} ) mod \frac{{R}_{P RB , CS}^{P S F C H}}{M \times N}$$
$$or$$
$$( n + m \cdot N ) \cdot \frac{{R}_{P RB , CS}^{P S F C H}}{M \times N} + ( {P}_{ID} + {M}_{ID} ) mod \frac{{R}_{P RB , CS}^{P S F C H}}{M \times N}$$
wherein
M is a number of possible transmit beams or time-domain resources for a sidelink transmission;
N is a number of possible frequency-domain resources for the sidelink transmission;
m indicates which of the possible transmit beams or time-domain resources is used by the sidelink transmission;
n indicates which of the possible frequency-domain resources is used by the sidelink transmission;
R_{PRB,CS}^{PSFCH} is a number of physical sidelink feedback channel transmission resources available for multiplexing control information in a physical sidelink feedback channel transmission;
P_{ID} is a physical layer source identifier; and
M_{ID} is a group member identifier.

37. The apparatus of claim 36 wherein:
m is an integer having a value that ranges from 0 to M−1, and
n is an integer having a value that ranges from 0 to N−1.

38. The apparatus of claim 36, wherein at least M is larger than 1.

39. The apparatus of claim 36, wherein physical sidelink feedback channel (PSFCH) transmission resources corresponding to PSFCH transmission resource indices associated with different values of m occur in different PSFCH transmission symbols within a same slot.

40. A method comprising:
determining a transmit beam or a time-domain resource associated with a sidelink transmission; and
determining at least one physical sidelink feedback channel transmission symbol within a slot for a physical sidelink feedback channel transmission in response to the sidelink transmission at least based on the determined transmit beam or time-domain resource.

41. An apparatus comprising:
means for determining a transmit beam or a time-domain resource associated with a sidelink transmission; and
means for determining at least one physical sidelink feedback channel transmission symbol within a slot for a physical sidelink feedback channel transmission in response to the sidelink transmission at least based on the determined transmit beam or time-domain resource.
